(19) United States
(12) Patent Application Publication
(10) Pub. No.: US 2026/0003669 A1
(43) Pub. Date: Jan. 1, 2026

(54) SPARSE DATA PROCESSING

(71) Applicant: Advanced Micro Devices, Inc., Santa Clara, CA (US)

(72) Inventor: Harris Gasparakis, Nashua, NH (US)

(73) Assignee: Advanced Micro Devices, Inc., Santa Clara, CA (US)

(21) Appl. No.: 18/754,458

(22) Filed: Jun. 26, 2024

(51) Int. Cl. G06F 9/48; G06F 16/908

(52) U.S. Cl. CPC G06F 9/4881; G06F 16/908; G06F 2209/486

(57) ABSTRACT

With some techniques described herein, efficiency of data processing operations may be increased by avoiding loading of data and/or avoiding execution of instructions that would operate on sparse data. In some implementations described herein, using metadata or other indications of whether data meets at least one criterion (e.g., a sparsity criterion), instructions may be executed on sparse data without incurring the time cost of loading the sparse data from a storage (e.g., memory), such as by creating new sparse data in a way that may be faster than loading it from memory or by performing the instructions with a representation of the sparse data or an indication of what an output of processing the sparse data would have been. In some implementations, additionally or alternatively some instructions may not be executed or may not be scheduled for execution, if the instructions are to process sparse data.

### BACKGROUND

A graphics processing unit (GPU) performs processing tasks, for example, graphics-processing tasks required by an end-user application, such as a video game. GPUs are also increasingly being used to perform other tasks which are unrelated to graphics.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an example computing system with which some implementations may operate.

FIG. 2 illustrates an exemplary matrix satisfying one or more criteria.

FIG. 3 illustrates an exemplary method of partitioning a data matrix to yield a matrix meeting at least one criterion, according to an implementation of some techniques described herein.

FIG. 4 is a block diagram illustrating omitting loading a wavefront to a GPU cache according to an implementation of some techniques described herein.

FIG. 5 is a block diagram illustrating omitting dispatching a wavefront to a compute unit of the GPU according to an implementation of some techniques described herein.

FIG. 6 is a flow diagram of an example method for processing sparse data.

FIG. 7 is a flow diagram of an example method for generating metadata that includes indications of blocks of data.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF SOME EXAMPLE IMPLEMENTATIONS

Described herein are examples of techniques for processing of data by a computing system, including techniques for processing sparse data. “Sparse” data may be data that follows some pattern or otherwise meets one or more criteria. In some cases, sparse data may be uniform in value, such as a set of data that all has a zero (0).

In accordance with some techniques described herein, efficiency of data processing operations may be increased by avoiding loading of data and/or avoiding execution of instructions that would operate on sparse data. In some implementations described herein, using metadata or other indications of whether data meets at least one criterion (e.g., a sparsity criterion), instructions may be executed on sparse data without incurring the time cost of loading the sparse data from a storage (e.g., memory), such as by creating new sparse data in a way that may be faster than loading it from memory or by performing the instructions with a representation of the sparse data or an indication of what an output of processing the sparse data would have been. In some implementations, additionally or alternatively some instructions may not be executed or may not be scheduled for execution, if the instructions are to process sparse data. For example, rather than performing instructions that would process sparse data, if a result of the operations on sparse data would be known, the known output may be generated as an alternative to performing the instructions, such that scheduling and/or execution of the instructions can be avoided. This operation can in some cases increase efficiency of processing of instructions and of data sets, which can in some cases be a significant efficiency gain.

In some examples described below, a controller circuit may be configured to evaluate whether sparse data is to be processed and, in such a case, not load the data for processing and/or not schedule instructions for execution. In other examples described below, additionally or alternatively a compiler may be configured to insert into a program being compiled new instructions (not included in the program that was input to be compiled) that would, when executed, evaluate whether sparse data is to be processed and, in such a case, not load the data for processing and/or not schedule certain instructions for execution. This may in some cases enable efficiency gains to be garnered even in situations where not controller circuit is available. In some such implementations, a program may be an entirety of a set of instructions to be loaded and run together, such as a set of instructions that are packaged and distributed together, or may be only a portion of such a set of instructions. In some implementations, such a program may be a set of instructions that are to be run on a graphics processing unit (GPU) or other set of circuits at a time.

In some situations, data processing operations may include performing a large number of data processing operations on a large number of sets of data, which may in some cases include performing the same instruction or a small number of instructions repeatedly across data sets. In some situations, this may include processing data as part of an artificial intelligence operation such as a machine learning operation. This could include processing input data with a model or processing data to train a model. As another example, computational fluid dynamics (CFD), partial differential equations (PDEs), graph algorithms, or other operations to be performed, including in the context of high performance computing, may include performing a large number of data processing operations on a large number of sets of data. Such operations may include matrix multiplication operations (GEMM), convolution operations, or other mathematical or logical operations.

In some uses of a GPU to perform a large number of data processing operations, a sequence of work-items, which can also be referred to as threads, are processed so as to output a final result. In some such cases, each processing element of the GPU executes a respective instantiation of a particular work-item to process data. A work-item may be performance of a set of instructions on data, and in some cases a collection of work-items may be performed together on a large set of data such that the same instructions of a kernel are performed in parallel within a compute unit of the GPU. A compute unit can be a collection of processing units, each being a circuit (e.g., single-instruction, multiple-data (SIMD) units), that can perform parallel (e.g., synchronous) execution of work-items on the compute unit. The number of processing elements per compute unit can vary from implementation to implementation. In some cases, the collection of work-items assigned to the compute unit, to perform the same instructions on data over time, may be arranged as a workgroup. A subset of work-items in a workgroup that execute simultaneously, synchronously, or in parallel together on a compute unit can be referred to as a wavefront, or as a warp or a vector. The width of a wavefront reflects a number of work-items executed in parallel and may be a characteristic of the hardware of the compute unit. Accordingly, in some cases, a set of instructions to be iteratively performed on a collection of data, such that the instructions are performed for each set of data, may be a workgroup; a synchronous or parallel instruction at a time of the instructions on multiple sets of data may be a wavefront; and an iteration of an execution of the instructions with a set of data may be a work-item. In some cases, a workgroup may include multiple sets of instructions, such as instructions that are performed with respect to different sets of data and instructions that operate on results of performance of those first instructions, or other instructions that may be arranged for performance together on a compute unit of a GPU.

When large numbers of operations are to be performed, for example in a workgroup for which instructions are to be executed across a set of data, there may be cases in which some of the data to be processed is or includes sparse data. As noted above, such sparse data may include data that is all zero (0) value. This may be the case, for example, with layers of a neural network that may have values of all zeros. Sparse data may have other uniform values, such as being all 1s or all another value, or otherwise meet a known pattern or one or more criteria.

The inventor has recognized and appreciated that, in a case that data to be processed is or includes sparse data, the loading of such sparse data and processing of such sparse data by executing instructions relating to the sparse data, inserts unnecessary inefficiencies (time and/or power) into the processing. Retrieving data from storage (e.g., memory) for processing may incur some amount of time to issue a request to storage to obtain the data and then to transfer the data from the storage to the circuit at which the data will be processed. If the value of the data was known in advance because, e.g., it is known to be sparse data that satisfies at least one criterion (e.g., all zeros), then this data transfer time may be unnecessary and a source of inefficiency. Even if the time is relatively small, repeated occurrences may add up to an appreciable amount of time, power, or other resources. It may be that generating the sparse data anew at the circuit that will process it may be faster, use less power, and/or otherwise be more efficient than transferring the data. If it could be known in advance that the data is sparse, steps could be taken to omit loading of the data from storage. Additionally, when sparse data is loaded into cache or registers for processing, other data must be moved out of the cache/registers to make room for the sparse data and possibly may need to be moved back later for future processing. Such cache operations take time, which might in some cases be saved if data did not need to be transferred from storage.

As a further example, it may be that instructions perform a mathematical operation or other operation on data when executed and may be that the result of such an operation may be known for sparse data. For example, if the sparse data is all zeros, a multiplication operation on the sparse data will also yield all zeros, as any number multiplied with zero would be zero; or an addition operation on the sparse data with other data will yield the other data, as any number added to zero would be that number. The inventors have recognized and appreciated that if the result of instructions operating on sparse data could be known in advance, execution of the instructions could be skipped and a result of the instructions passed (e.g., to storage, or to another instruction) as if the instructions were executed. Omitting execution of the instructions may therefore increase efficiency in time, power, and/or other resources. This may be particularly the case where there are a large number of instructions competing for compute resources, and if there are occasions where executions of instructions is being blocked while a scheduler waits for sufficient resources to execute a next set of instructions (e.g., execute the same instructions with a next set of data). If a set of instructions or a set of can be skipped, a next instruction can be executed more quickly, and overall execution efficiency can be increased.

Conventionally, no approach was available for knowing at runtime whether data that is not yet retrieved and is to be executed is sparse, and no way of knowing prior to retrieval and analysis of the data that an operation is to be performed on sparse data and could be omitted. Described herein are various techniques for configuring sets of data to be stored together with an indication of whether the set of data is sparse or otherwise meets at least one criterion. In accordance with some techniques described herein, metadata or another indication may be used to indicate whether at least one criterion is met by a set of data. When the set of data is to be loaded and/or an instruction is to be scheduled for execution and/or to be executed that would process the set of data, the indication may be used to determine whether to omit loading of the data, and/or scheduling and/or execution of the instruction.

Some examples described herein employ an exemplary scheduler of the computing system, where the scheduler is configured to omit loading and/or dispatching a block of data in response to an indication that the block of data is sparse or otherwise meets at least one criterion. Such a scheduler may in some cases be a circuit that schedules instructions for execution on one or more circuits. In some cases, the circuit(s) may be portions of a graphics processing unit (GPU) or other circuit.

As noted above, a GPU can in some implementations schedule work to be performed by its underlying compute resources using workgroups and wavefronts. For example, a workgroup can be dispatched to be processed by a compute unit when that compute unit has sufficient resources to support processing of the workgroup, including all parts of the workgroup. Such compute unit resources may include at least vector and scalar registers, wavefront slots, and local data share (LDS) space, among other resources. A workgroup may include instructions that are to be executed (or otherwise, operations to be performed) with respect to sets of data. A collection of such data that is to be executed in parallel or synchronously at a time with resources of the compute unit may be a wavefront.

In some implementations described herein that operate with workgroups and/or wavefronts, a controller circuit that is a scheduler for a set of circuits to process data (e.g., a scheduler for a GPU) may implement techniques described herein to determine whether to schedule a workgroup and/or a wavefront for execution. For example, with respect to a workgroup that is eligible to be scheduled, the controller circuit may determine whether data to be processed by the workgroup satisfies at least one criterion (e.g., is sparse or matches a pattern). If so, the controller circuit may determine not to load the data from storage (e.g., memory or disk) and may instead schedule the workgroup for execution with the sparse data, without loading that data from storage. For example, the controller circuit may trigger generation of sparse data to be processed, which may be faster than retrieving the sparse data. Or, in some implementations, in addition to omitting loading of the data from storage, the controller circuit may omit scheduling of the workgroup for execution, if the data meets the criterion (e.g., is sparse). For example, if a result of executing the instructions of the workgroup on the data meeting the criterion would be known, the controller circuit may trigger output of the result as if the instructions had been executed, without scheduling the workgroup for execution and without performing the operations on the data. In some such cases, the result may be output to storage or provided as an input to other instructions, for example, to another workgroup. Such an output may be a single value, a vector or matrix of values, multiple different values, or any other suitable output of a set of operations, as implementations are not limited in this respect.

In some implementations, in addition to or as an alternative to performing such functionality at a workgroup level, a controller circuit may perform operations at the level of a wavefront that is a subset of a workgroup. For example, a controller circuit may determine that data to be processed by a wavefront meets at least one criterion (e.g., is sparse or matches a pattern). If so, as discussed above, the controller circuit may omit loading of that data for processing and/or may omit execution of the instructions for the wavefront on such data. In some such cases, the controller circuit may trigger output of a known result of such operations on the data, if the output would have been known.

In some implementations, a controller circuit may be configured to select a workgroup size and/or a wavefront size to enable gains in efficiency, such as by enabling identification of a workgroup and/or a wavefront and/or a set of instructions to be performed with respect to a set of data that satisfies at least one criterion. For example, in some situations a set of data may include both sparse data and non-sparse data, or otherwise include data both meeting at least one criterion and data not meeting the criterion. In such a case, in accordance with some techniques described herein, the data may be partitioned to create one or more sets of data that meets the at least one criterion and that do not meet the at least one criterion. Workgroups, wavefronts, or sets of instructions may then be identified such that some of the workgroups/wavefronts/instructions sets are associated with sparse data. For example, a size of a wavefront or a size of a work group may be identified that is different from a hardware size of a wavefront and that enables identification of data that meets the criterion/criteria and for which loading of data or execution of instructions can be omitted.

In some implementations, a compiler may enable creation of a set of instructions to determine whether data and/or instructions may be omitted from scheduling, loading, and/or execution. As noted above, in some cases a controller circuit may be configured to determine, prior to scheduling loading of data or execution of instructions, whether data that would be processed meets at least one criterion. Some implementations may operate without a circuit configured to perform such a check of data, or may be configured to operate without such a circuit. To do so, a compiler may insert into a program to be compiled new instructions (not specified by the program) that are to be executed include a check of whether data to be processed meets at least one criterion. The new instructions may specify that if the data meets the criterion, the data should not be loaded from storage and/or processing of the data should be skipped.

In some implementations described herein, data may be stored with an indication of whether the data meets at least one criterion. For example, a data structure for data may be associated with one or more fields indicating whether the criterion is met. As one specific example, in some illustrative multi-step processing pipelines, such as those that may be used with machine learning, data may be passed between stages of a pipeline such that a result of processing data in one stage of the pipeline may be passed to a later stage of the pipeline. In such a case, as data is generated by one stage of the pipeline, if the data is determined to satisfy one or more criteria (e.g., the data is sparse), an indication of the data's sparsity may be stored. In some such implementations, subsequently, when data is to be written to the data structure, a determination may be made of whether the data meets the criterion and the field may be updated. In some such implementations, when a controller circuit and/or instructions are to determine whether the data meets the criterion, the circuit/instructions may retrieve the value of the field to determine whether the criterion is met and, if so, omit loading of the data or scheduling/execution of the instructions to process the data.

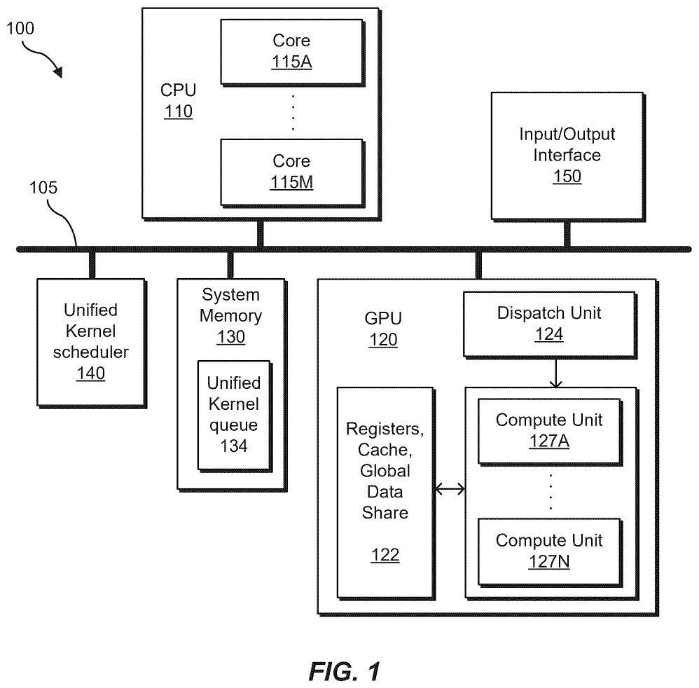

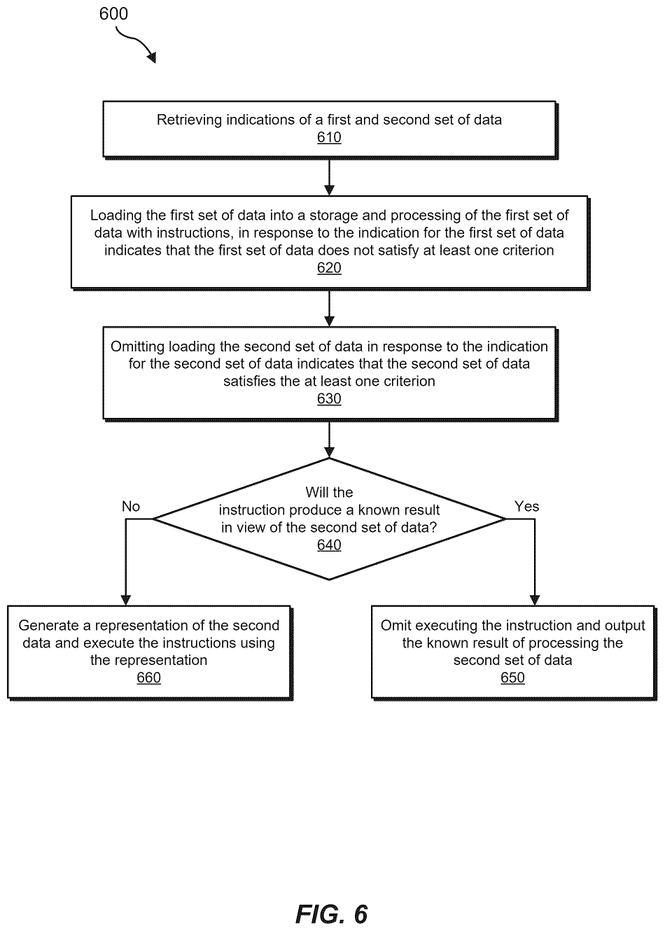

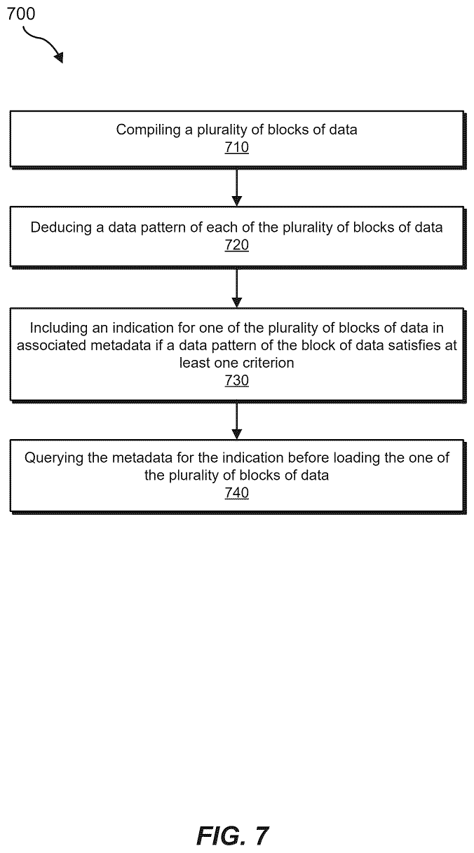

The following will provide, with reference to FIGS. 1-5, detailed descriptions of example systems for processing sparse data. Detailed descriptions of corresponding computer-implemented methods will also be provided in connection with FIGS. 6-7. It should be appreciated that implementations are not limited to operating in accordance with the examples of FIGS. 1-7, as these are merely illustrative of various implementations that may be created. Other implementations are possible.

Prior to describing the example of FIG. 1, some specific example implementations are described.

In one illustrative implementation, there is provided a method comprising, prior to executing at least one instruction that is to process a first set of data stored in at least one storage, retrieving from the at least one storage a first indication of whether the first set of data satisfies at least one criterion and omitting loading the first set of data from the at least one storage for processing with the at least one instruction in response to the first indication indicating that the first block of data satisfies the at least one criterion.

Such an implementation may further comprise omitting executing the at least one instruction in response to the first indication indicating that the first set of data satisfies the at least one criterion.

In such an implementation, omitting executing the at least one instruction may comprise omitting loading the at least one instruction into at least one second storage.

In such an implementation, the at least one criterion may be that the first set of data consists of zero value data.

In such an implementation, the first set of data may be stored in the at least one storage as a data structure comprising at least one metadata field, the at least one metadata field of the data structure indicating whether data stored in the data structure satisfies the at least one criterion, and retrieving the indication from the at least one storage may comprise retrieving one or more values of the at least one metadata field of the data structure for the first set of data.

Such an implementation may further comprise loading a second set of data in response to a second indication indicating that the second set of data does not satisfy the at least one criterion, and executing the at least one instruction with the second set of data and a data value representing the first set of data.

In such an implementation, executing the at least one instruction may comprise dispatching the second set of data to one of a plurality of compute units, and providing the data value to the one of the plurality of compute units.

Such an implementation may further comprise partitioning a second set of data to obtain the first set of data satisfying the at least one criterion.

Such an implementation may further comprise storing, in association with the first set of data, metadata indicating a data pattern of the first block of data.

In another illustrative implementation there is provided a system comprising a plurality of circuits to process data, at least one storage coupled to the plurality of circuits, and a controller circuit. The controller circuit is configured to retrieve from the at least one storage a first indication of whether a first set of data satisfies at least one criterion and omit scheduling the first set of data for processing by one of the plurality of circuits with at least one instruction in response to the first indication indicating that the first set of data satisfies the at least one criterion.

In such an implementation, the controller circuit may be further configured to omit scheduling the at least one instruction for execution on one of the plurality of circuits in response to the indication indicating that the first set of data satisfies the at least one criterion.

In such an implementation, the first set of data may be stored in the at least one storage as a data structure comprising at least one metadata field, the at least one metadata field of the data structure indicating whether data stored in the data structure satisfies the at least one criterion, and retrieving the indication from the at least one storage may comprise retrieving one or more values of the at least one metadata field of the data structure for the first set of data.

In such an implementation, the controller circuit may be further configured to load a second set of data in response to a second indication indicating that the second set of data does not satisfy the at least one criterion and execute the at least one instruction with the second set of data and a data value representing the first set of data.

In such an implementation, the controller circuit may be configured to process data as one of the plurality of circuits.

In such an implementation, the controller circuit may be configured to perform the act of retrieving the first indication and configured to perform the act of omitting scheduling the first set of data for processing by performing executing instructions that, when executed by the controller circuit, cause the controller circuit to perform the retrieving and the omitting.

In another illustrative implementation, there is provided at least one computer-readable storage medium having encoded thereon executable instructions that, when executed by at least one processor, cause the at least one processor to carry out a method. The method comprises compiling a program for execution by at least one circuit to process data, wherein compiling the program comprises compiling a plurality of instruction partitions of the program to be separately executed by the at least one circuit, each instruction partition of the plurality of instruction partitions being arranged to process a different set of data of a plurality of sets of data. The compiling comprises, for an instruction partition of the plurality of instruction partitions, compiling instructions of the program that allocate the set of data, that is to be processed by the instruction partition, to include instructions to associate the set of data with an indication of whether the set of data satisfies at least one criterion, and compiling instructions of the program that store data into the set of data to include instructions additionally storing the indication of whether the set of data satisfies the at least one criterion.

In such an implementation, the compiling may further comprise, for the instruction partition of the plurality of instruction partitions, compiling instructions of the program to include instructions that, when the instruction partition is to be scheduled for execution, refrain from scheduling the instruction partition for execution in response to the indication indicating that the set of data satisfies the at least one criterion.

In such an implementation, the compiling to include the instructions to refrain from scheduling the instruction partition for execution may comprise inserting new instructions not specified by the program to be compiled.

In such an implementation, the compiling to include the instructions to store the set of data in association with the indication and the compiling to include the instructions to additionally store the indication of whether the set of data satisfies the at least one criterion may comprise inserting new instructions not specified in the program to be compiled.

In such an implementation, the compiling may further comprise, for the instruction partition of the plurality of instruction partitions, compiling instructions of the program to include instructions that, when the instruction partition is to be scheduled for execution, refrain from loading the set of data for processing in response to the indication indicating that the block of data satisfies the at least one criterion, wherein the compiling to include the instructions that refrain from loading the block of data comprises inserting new instructions not specified in the program.

FIG. 1 is a block diagram of an example computing system 100. As illustrated in this figure, example computing system 100 includes CPU 110, GPU 120, system memory 130, unified kernel scheduler 140, input/output interface 150 and bus 105 that links all the above components. Computing system 100 also includes other components that are not shown to avoid obscuring the figure. System 100 may be or be a part of a variety of different computing systems that may include a CPU and/or a GPU (or other co-processor, accelerator, or offload hardware), such as a server within a data center, a server within a cloud computing system, a standalone server, a laptop or desktop personal computer, television, video gaming system, a mobile device, a vehicle (land, air, or water vehicle), or other system that may be or include the components of the system of FIG. 1.

CPU 110 can in some implementations include at least a plurality of cores 115A-M for executing program instructions. The cores may, in some implementations, be arranged in separate chiplets. The instructions can be in some cases CPU instructions (such as add, move data and branch) but can be run on separate cores 115A-M at the same time, which may increase overall speed for programs that support multithreading or other parallel computing techniques. It should be appreciated, however, that implementations are not limited to operating with any particular type of CPU instructions, or with any particular type of CPU or, in a case that a CPU 110 includes multiple cores, any particular type of core(s). If CPU 110 includes multiple cores, it can include more or less than the CPU cores in the example chosen, and can also have cache memories or other appropriate storages.

GPU 120 may be adapted to perform mathematical operations, including matrix operations, that may be performed for a variety of purposes. This may include performing operations to accelerate computer graphics and image processing (either on a video card or embedded on motherboards, mobile phones, personal computers, workstations, and game consoles), but GPU 120 can also be used for non-graphic calculations involving parallel operations due to their parallel structure. Other non-graphical uses include the training of neural networks or other artificial intelligence and machine learning operations, computational fluid dynamics, partial differential equation solving, and cryptocurrency mining.

GPU 120 in the example of FIG. 1 includes at least registers, cache, and global data share 122, dispatch unit 124, and a plurality of compute units 127A-N. In other implementations, GPU 105 includes other components, omits one or more of the illustrated components, has multiple instances of a component even if only one instance is shown in FIG. 1, and/or is organized in other suitable manners. For example, in another implementation, GPU 105 includes multiple dispatch units.

While FIG. 1 illustrates a GPU 120, it should be appreciated that implementations are not limited to operating with a GPU. GPU 120 could, in other implementations, be any suitable co-processor (e.g., parallel processor), accelerator, or other offload hardware that may perform operations offloaded from the CPU 110. In some implementations, in addition to or as an alternative to GPU 120, the system 100 may include one or more neural processing units (NPUs), tensor processing units (TPUs), other highly parallel processor units (PPU), or other accelerator. Instructions may be offloaded for any suitable reason, which in some cases may be or include that the offload hardware (e.g., co-processor) may include hardware that is adapted to execute such instructions more quickly or otherwise with greater efficiency than CPU 110, or may be specially adapted to perform such instructions. For example, matrix operations may be offloaded from CPU 110 to offload hardware, such as to a GPU 120 or other hardware. If a set of instructions are to be performed on multiple data, offload hardware may be single-instruction-multiple-data (SIMD) or single-instruction-multiple-threading (SIMT) hardware to perform the instructions on the data. Any suitable offload hardware (GPU, SIMD, SIMT, or other) may be used in implementations that include offload hardware. It should also be appreciated that implementations are not limited to operating with offload hardware or co-processors, and that some implementations described herein may operate with CPU 110.

For ease of readability, the example of FIG. 1 and various examples below may be described in connection with one or more GPUs, but it should be appreciated that, unless indicated otherwise by the text, other implementations of these examples may be created that additionally or alternatively include one or more other co-processors, accelerators, or other offload hardware, including one or more of SIMD circuitry, SIMT circuitry, NPU(s), TPU(s), PPU(s), or other processing circuits. And, some embodiments may operate with CPUs, such as CPUs with SIMD circuitry (e.g., Advanced Vector Extensions (AVX) hardware in a CPU). Accordingly, examples described below, unless indicated otherwise, may be adapted for other examples to operate without a GPU and with one or more of the foregoing circuits.

Registers, cache, and global data share 122 in GPU 120 stores data so that future requests for that data can be served faster to compute units 127A-N. Registers, cache, and global data share 122 also manages data coherence among compute units 127A-N. Cache 122 is, for example, formed by static random access memory (SRAM) or dynamic random access memory (DRAM), or other suitable storage. Implementations are not limited to a particular form of storage in element 122.

Each of the plurality of compute unit 127A-N in GPU 120 can independently execute program instructions, so that GPU 120 can efficiently perform parallel operations. The compute units may each include computing resources to perform mathematical, logical, or other operations on data, such as circuits to store data and/or circuits to perform operations (e.g., execute instructions). Such circuits may include one or more Single Instruction Multiple Data (SIMD) unit(s), arithmetic and logic unit(s) (ALUs), scalar unit(s), texture filter unit(s), texture mapping units, floating-point processors, vector processors, scalar processors, caches (including instruction caches, local data shares, data caches), registers (including vector registers, scalar registers, and other registers), queues, memory, and/or other circuits. (Those skilled in the art will appreciate that each of the foregoing units, registers, caches, etc., would be implemented in circuitry.) Such circuits may be referred to as processing elements. Compute units may be organized in some cases into clusters and/or cores.

In some implementations, dispatch unit 124 (which may be or include a circuit, such as a dedicated circuit or instructions executing on a circuit such as a controller or processor) receives workgroups for dispatch and determines how to schedule and/or dispatch the workgroups to the plurality of compute units 127A-N based on the calculated load-ratings. In some implementations, a workgroup cannot be parsed and is assigned as a whole to a compute unit. In some other implementations, if a workgroup is unable to fit in a single compute unit 127A-N within a given time window based on the currently available resources of the compute units 127A-N, the dispatch unit may divide the workgroup into its individual wavefronts and dispatches wavefronts of the workgroup to different compute units 127A-N. The dispatch unit 124 determines how to dispatch the wavefronts to specific ones of the compute units 127A-N based on the calculated load-ratings.

GPU 120 may include other components not illustrated in FIG. 1, such as one or more command processors, one or more front-end circuits, one or more acceleration circuits, one or more scheduling circuits, or other elements. GPU 120 may also have a suitable interface for communicating with other elements of system 100, such as a suitable interface for communicating via a system bus (examples of which are described below).

System memory 130 can include at least one non-persistent memory such as DRAM. System memory 130 can hold processing logic instructions, constant values and variable values during execution of portions of applications or other processing logic. For example, in one implementation, the control logic and/or other processing logic of unified kernel queue 134 can reside within system memory 130.

In implementations, unified kernel queue 134 includes one or more queues into which application programs place kernels to be executed, such as one queue from each client or other source of assignment for work for the GPU 120. Compute kernels can be assigned to processors upon placement of new kernels in unified queue 134 or a workload queue threshold in one or more processor-specific queues indicating that the particular queue(s) have reached a configured threshold indicating that the corresponding one or more processors are available to be assigned kernels for processing.

Unified kernel scheduler 140 operates to schedule functions and processing logic on one more types of processors available in computing system 100. While scheduler 140 is illustrated separate from CPU 110 and GPU 120, it may be a component of CPU 110 or GPU 120. In a case that scheduler 140 is a component of GPU 120, it may be the same circuit as dispatch unit 124 and/or may be one of the compute units 127A-127N. Unified kernel scheduler 140 may schedule compute kernels from unified kernel queue 134. The kernels scheduled by the unified kernel scheduler 140 can be executable on one or more types of processors in computing system 100. Some kernels may execute the same code on different types of processors. For some other kernels, programmer-specified instructions can be enhanced during compilation as necessary to execute on the different types of processors.

System bus 105 can include a Peripheral Component interconnect (PCI) bus, Advanced Microcontroller Bus Architecture (AMBA) bus, Industry Standard Architecture (ISA) bus, or other such industry-standard or proprietary device. System bus 105 can also include a network such as a local area network (LAN). System bus 105 may also be an on-chip bus or other on-chip interconnection network in systems where multiple processing units (e.g. CPU cores 115A-M and GPU compute units 127A-N) are integrated on a single die or chip. System bus 105 can also include a hierarchy of busses or interconnection networks such that processing cores within a chip are interconnected via on-chip mechanisms and multiple such chips are interconnected via off-chip mechanisms. System bus 105 includes the functionality to couple components including components of computing system 100.

Input/output interface 150 includes one or more interfaces connecting user input/output devices such as keyboard, mouse, display and/or touch screen. For example, user input can be provided through a keyboard and mouse connected through user interface 150 to computing system 100. The output of computing system 100, such as the output of processing performed on CPU 110, can be output to a display through user interface 150.

As discussed above, in high performance computer (HPC), machine learning (ML), or other contexts, situations can arise involving mathematical or other operations in which sets (e.g., blocks or hyperblocks) of data do not need to be loaded or processed, because they satisfy at least one criterion, such as matching a pattern (e.g., being identical data, such as the same number). For example, a set of data may be fully logic “0”, which may mean that the data would not contribute to whatever mathematical operations (e.g., a general matrix multiply (GEMM) or a convolution) are being performed. However, it is very common that, in situations like that, the data needs to be loaded, i.e., incurring high penalties of memory fetches also polluting the caches, and furthermore, on GPU implementations, workgroups/dispatches need to be scheduled and executed (also incurring further latency), and once launched, they simply calculate zeros, and write back to memory zeros. All the above may introduce inefficiencies that could be avoided. Techniques described herein may reduce or mitigate, or even eliminate, those inefficiencies.

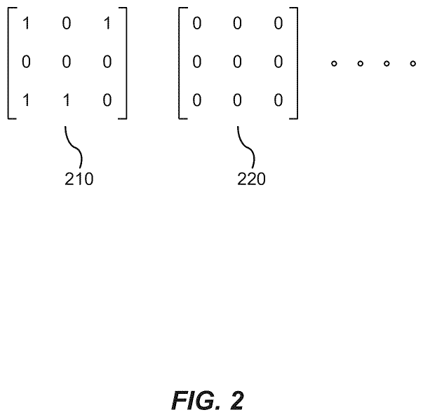

FIG. 2 illustrates an exemplary matrix with a uniform value. In this figure, matrixes 210 and 220 exemplarily have three rows and three columns. Entries in matrix 210 include both logic “1” and logic “0”, thus are not uniform. Entries in matrix 220, however, include only logic “0”, thus are of a uniform value. If matrix 220 is a factor in a multiplication, the product will be a matrix of logic “0”. Similarly, if matrix 220 is a term in a summation, the sum will remain unchanged from other terms in the summation. In view of such situations, techniques described herein may be used to determine that matrix 220 satisfies at least one criterion and therefore omit loading and/or processing of matrix 220 to reduce processing resources, while still loading and/or processing matrix 210 that does not meet at least one criterion.

In an implementation, the uniformity of a matrix can be detected by measuring a weight of the matrix, i.e., summing up all the numbers in the matrix. A matrix having all logic “0” has the lowest weight; and a matrix having all logic “1” has the highest weight. Such weight value can be stored in metadata. In some implementations, before processing the matrix (e.g., loading it into cache 122 or dispatching it to a compute unit 127A-N for processing), a circuit (e.g., scheduler 140, GPU 120, CPU 110, or another dedicated circuit or circuit performing instructions) first queries the metadata and omits processing a matrix if the metadata indicates that at least one criterion is met, for example, that the matrix is of uniform entry pattern, e.g., having a weight representing all logic “0”. In another implementation, a sparsity bit (e.g., logic “0” means “empty”, and logic “1” means “not empty”) can be associated with every input data range. GPU 120 first queries the sparsity bits before processing the input data. If it is determined that the matrix meets the at least one criterion, loading of the matrix and/or processing of the matrix can be omitted. Sparsity bits can also in some implementations encode a spatial view of data. For example, sparsity bits may apply “per row” or “per column” of a matrix, if data is arranged in a matrix. As another example, for other data structures, sparsity bits may apply “per slice” or “per block.” Sparsity bits can be calculated either by the kernel/workgroup/wavefront that produces the data, by the memory hardware that writes the data in memory (e.g., the cache controller, or the memory controller, or other hardware), or any other circuit, as implementations are not limited in this respect.

In some implementations that operate with such metadata, when storage (e.g., memory space) is allocated to store data and/or a data structure is created to store data, additional storage may be allocated and/or a metadata field added to the data structure to hold the weight, sparsity bit, or other indication of whether at least one criterion is met. When data is to be written to the storage and/or data structure, a determination may be made of whether the criterion is met. If so, an indication (e.g., a bit or other value) may be stored in the additional storage or field to indicate that the criterion is met. Subsequently, when an operation is to be performed on the data, the storage/metadata may be checked to determine whether the criterion is met and, in accordance with some techniques described herein, the data may not be loaded and/or instructions to process the data not performed. The circuit may also be arranged to, when instructions to process data are not to be performed, output data that is known to result from performance of the operations on data that meets the one or more criteria, to a storage, to an input of another instruction or workgroup, or other destination. Such a result may be a known scalar value, a matrix of known values, or other suitable result, as implementations are not limited in this respect.

The allocation of the additional storage or field of the data structure, and the determining of whether the one or more criteria are met, may be performed by a controller circuit is some implementations. When instructions to allocate storage for data are to be performed, the controller circuit may, in response to detecting that such allocation instructions are to be executed, additionally allocate storage or an additional field of a data structure to have storage for such metadata or an indication of whether the one or more criteria are met. In addition, when instructions to access data are to be executed, the controller circuit may, in response to detection of such an instruction to access data, first retrieve the indication of whether the criterion is met and determine from that indication whether the criterion is met. If so, the circuit may omit loading data and/or scheduling or execution of instructions for processing the data.

In other implementations, in addition to or as an alternative to such a controller circuit, a compiler that is compiling instructions to be performed on data may analyze the instructions during compilation and insert additional, new instructions not specified by the input instructions. The input instructions may be a program, which may be an entirety of a discrete program or a portion of a larger program, and the program may be arranged to run on any suitable computing hardware and may be being compiled to run on such computing hardware, including parallel computing hardware. Such new instructions that are inserted by the compiler may be arranged to, in connection with input instructions of the input program that allocate storage, allocate additional storage to store an indication of whether one or more criteria are met. Such new instructions that are inserted by the compiler may be arranged to, in connection with input instructions of the input program that allocate a data structure to store data, allocate additional fields of the data structure, such as of metadata, to store the indication of whether one or more criteria are met. Such new instructions that are inserted by the compiler may be arranged to, in connection with input instructions of the input program that store data in such a storage, determine whether the one or more criteria are met by the data (e.g., determine whether the data is all of one value, matches another pattern, or matches other criteria) and store the indication of whether the data is met. Such new instructions that are inserted by the compiler may be arranged to, in connection with input instructions of the input program that access data from storage, check the indication of whether the one or more criteria are met and, if so, omit loading of the data and/or scheduling or execution of the instructions to process the data. In some implementations, if loading of the data is omitted by execution of the instructions continues, the instructions may process on data that was generated that meets the one or more criteria, but that was not loaded from storage. Such new instructions that are inserted by the compiler may be arranged to, in connection with input instructions of the input program that process data, output a known result of performing the operations on the data that meets the criterion (e.g., output a zero value, or all-zero matrix, or other output known to result from operation on such data), where such output may be to storage, to an input of another instruction or a workgroup, or other destination. Alternatively, according to a different implementation, instructions that store data can trigger calculation of sparsity bits or an indication of whether one or more criteria are met, if this triggering is supported by hardware. In some such implementations, such sparsity bits or indications can be read by circuits or executing instructions when a kernel or workgroup is scheduled or to be scheduled that will utilize such data, such as instructions that load data.

While the example of FIG. 2 included determining whether a relatively small 3×3 matrix satisfies a criterion, it should be appreciated that implementations are not limited to operating with a single matrix or matrices of any particular size, and that implementations are not limited to operating with matrices. Implementations can operate with any suitable data to perform techniques described herein.

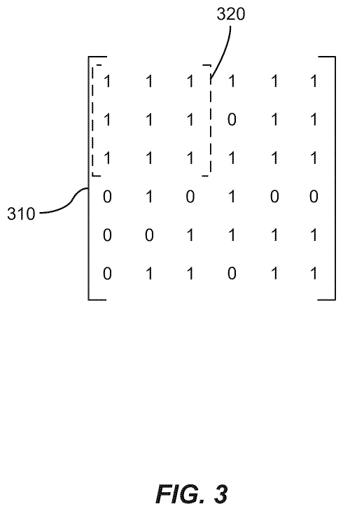

FIG. 3 illustrates an exemplary method of processing existing data to obtain a matrix that meets at least one criterion according to some implementations of techniques described herein. This figure illustrates a matrix 310, and in this example, the criterion is that the matrix contains values that are all one (1). Entries in matrix 310 include both logic “1” and logic “0”, and thus the matrix 310 does not meet the criterion. Because matrix 310 does not meet the criterion, all values of matrix 310 need to be processed and no values will not be processed. Matrix 320, however, is a subset of matrix 310 that includes values that are all one (1) and thus meets the criterion. As matrix 320 meets the criterion and can be omitted in several loading and/or processing steps per some techniques described herein, it may be desirable to reduce the dimension of matrices processed in each iteration of processing from the 6×6 dimension of matrix 310 to the 3×3 dimension of matrix 320. Reducing matrix dimension may increase the number of matrixes to be processed for a given dataset (in this example, rather than one matrix, there are now four matrices). But an evaluation can be made of whether processing three smaller matrices and not processing the values of matrix 320 may be more efficient in this example processing context than processing all values of matrix 310. Accordingly, in some implementations a controller circuit responsible for dispatch may analyze sets of data to be processed and dynamically choose wavefront size or data block sizes so as to yield some data sets that satisfy one or more criteria and for which loading or processing of data may be omitted.

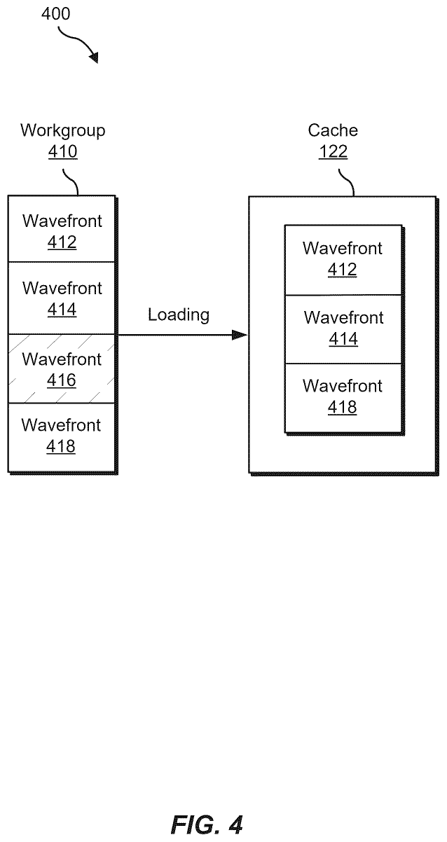

FIG. 4 is a block diagram illustrating omitting loading a wavefront to GPU cache 122 according to an implementation of some techniques described herein. In this example, a workgroup 410 includes four wavefronts 412-418. One of the wavefronts, wavefront 416, is to process data where the data is associated with an indication that one or more criteria are met, for example, that all the data for the wavefront is sparse. This may mean, as one example, that one or more matrices or other values to be processed in this wavefront 416 by instructions of the workgroup 410 are the same value, such as all being logic “0” or otherwise having zero value. In the case that wavefront 416 is associated with multiple units of data, such as multiple matrices or multiple sets of data, there may be multiple indications that the criterion/criteria are met by each of the values/matrices/data sets of the wavefront 416. In other implementations, there may be one indication for the data of wavefront 416 of whether the set of all data that is to be processed in wavefront 416 meets the one or more criteria.

In an implementation, data for wavefronts 412, 414, and 418 that do not meet the one or more criteria are loaded into cache 122 of GPU 120 shown in FIG. 1 for being processed by compute units 127A-N. Data for wavefront 416, since it was determined from the indication to meet the one or more criteria, is not loaded from storage (e.g., memory) into GPU cache 122. In other words, the loading of the data for wavefront 416 has been omitted.

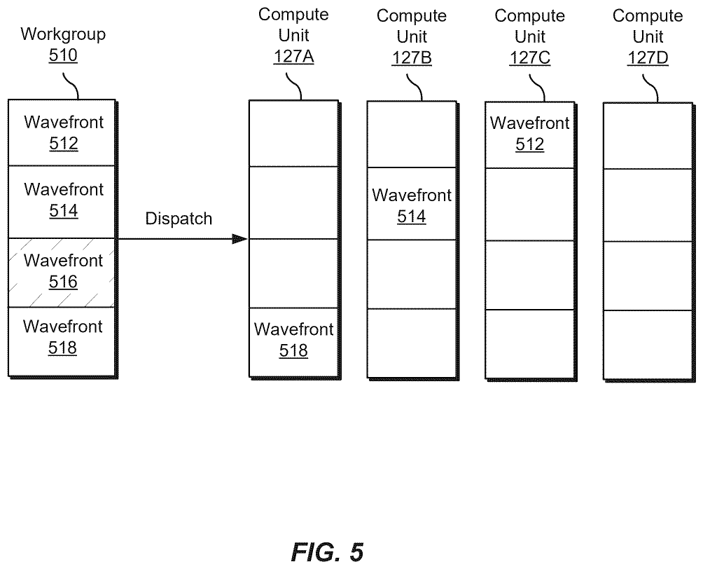

FIG. 5 is a block diagram illustrating omitting dispatching a wavefront to a compute unit of the GPU according to some implementations of techniques described herein. In this figure, an exemplary workgroup 510 has four wavefronts 512, 514, 516 and 518, and data for wavefront 516 satisfies one or more criteria specified for this example (e.g., the data of wavefront 516 is sparse). In an implementation, wavefront 512 is dispatched to compute unit 127C of GPU 120 (shown in FIG. 1); and wavefront 514 is dispatched to compute unit 127B; and wavefront 518 is dispatched to compute unit 127A. In response to a determination that the data of wavefront 516 satisfies the one or more criteria, such as by retrieving an indication (associated with the data) of whether the one or more criteria are met, the wavefront 516 is omitted from being scheduled for execution and not dispatched to any compute unit. This means no compute unit is configured to perform the instructions of workgroup 510 on the data of wavefront 516. In addition, loading of the data of wavefront 516 from storage for processing is also omitted.

In some implementations, in response to a determination that the indication associated with the data for wavefront 516 indicates that the data meets the one or more criteria, a known result of processing of wavefront 516 may be output. For example, if the criterion is that the data for wavefront 516 is all 0s, and the indication is that the criterion is met, then the data is known to be all 0s. If the instructions of workgroup 510 perform a multiplication operation on the data, then it can be known in advance that the result of the multiplication is all zeros (since zero multiplied with any number is zero). The known result may thus be output instead of performing the instructions on the data of wavefront 516. The known result (which may be a scalar, matrix, or other value, and could be one or more values, as implementations are not limited to operating with any particular operations or any particular results) may be output to a storage, output to be provided as input to another instruction (of workgroup 510, or another workgroup), or output in any other manner.

In some implementations, metadata is associated with each dispatch. This metadata contains indications of whether data stored in ranges of a memory accessed by the dispatches are, for instance, “empty”. A dispatch scheduler queries the metadata and only launches a dispatch if the associated data are not empty, and otherwise omits launching the dispatch and omits loading the data and scheduling the processing of the data.

In some implementations, a program identifies a workgroup's identification (ID) in the form of thread ID and block ID, with which the program acquires information on what data needs to be loaded and what data needs to be created. In some cases, metadata may be associated with the thread ID and/or block ID, and may be used to determine whether to schedule any of the data for loading or processing, or whether to omit such loading or processing.

In some implementations, when a compiler compiles a compute kernel, data dependencies can be identified by the compiler. For example, in calculating a matrix multiplication, the compiler will deduce memory ranges to fetch data from to form a workgroup. In this implementation, there is metadata associated with each portion of the matrix. During runtime, the metadata is retrieved for a portion of the matrix which is going to be used in the workgroup. If the metadata indicates all of the data in a memory range meets one or more criteria, unified kernel schedular 140 (shown in FIG. 1) will omit scheduling wavefront(s) formed by the data in this memory range.

In some implementations, when data is generated during execution, associated metadata may also be updated to include identifications of whether one or more criteria are met (e.g., whether data entries within the range are logic “0”). The kernel scheduler will always query the metadata and omit scheduling any data range that is identified as having a uniform entry pattern.

In some other implementations, when data is generated during execution, and it is written to storage, cache controller and/or memory controller hardware can update the indications of whether the one or more criteria are met (e.g., sparsity bits) that correspond to storage locations they control (e.g., cachelines, or hardware defined blocks), and create an encoding that saves the sparsity bits together with the payload. In some such cases, the same hardware can also read the corresponding indications (e.g., sparsity bits) when it is to load the data from storage.

FIG. 6 is a flow diagram of an example method 600 for processing data. The steps shown in FIG. 6 can be performed by any suitable circuit, computer-executable code, and/or computing system, including system 100 in FIG. 1, and/or variations or combinations of one or more of the same. In the example described below, the operations of FIG. 6 are performed by a controller circuit. In other examples, a compiler, when compiling a program for execution on computing hardware, may analyze the instructions of the program to identify instructions that interact with data and, for the instructions that access data for processing (e.g., for a wavefront of a workgroup), insert new instructions not specified in the program that perform the operations of FIG. 6. In one example, each of the steps shown in FIG. 6 can represent a process whose structure includes and/or is represented by multiple sub-steps, examples of which will be provided in greater detail below.

As illustrated in FIG. 6, at block 610, the controller circuit retrieves indications each associated with both a first and second set of data. Each indication may contain data (e.g., a value) indicative of whether one or more criteria are met. The criteria may indicate whether the set of data associated with the indication matches a known data pattern, for example, containing all the same value. The indication may indicate, for example, whether the set of data associated with the indication is sparse. In the specific example of FIG. 6, the value is zero (0), such that the criterion is that the data is all zeros (0s).

At block 620, the controller circuit described herein triggers loading the first set of data into a storage in response to the indication for the first block of data indicates that the first block of data does not satisfy at least one criterion. Such a storage may be, for example, a cache or register, or a memory or other data store. For example, in block 620, data for the first set of data may be loaded from system memory to a local cache for processing of the first set of data. In addition, in block 620, instructions are scheduled for execution and are performed on the first set of data.

At block 630, the controller circuit omits loading the second set of data into storage in response to the indication for the second set of data indicates that the second set of data satisfies the one or more criterion. In doing so, the controller circuit may enable reducing processing resources used in processing the first and second blocks of data.

At block 640, the controller circuit determines whether executing the instructions in connection with the second set of data would produce a known result when the second set of data is known to satisfy the one or more criteria. The controller circuit may make this determination based on an analysis of instructions to be performed with the data of the second set. For example, if the instructions to be performed on the second set of data are or include a summation of the second block of data with another value, because the second set of data is known to be all zeros, the result is known to be that other value (zero added to the other value is zero). Similarly, if the instructions to be performed are or include a multiplication of the second set of data with another value, that will also produce a known product, i.e., zero, as zero multiplied by any other value is zero. Accordingly, the controller circuit may analyze the instructions to be performed on or with the second set of data and determine whether the result of the instructions would be known.

If the result would be known, the controller circuit may determine that executing of the instructions on the second set of data can be omitted. Accordingly, at block 650, scheduling and execution of instructions for processing the second set of data is omitted. In addition, the known result of performing the instructions on the second set of data is output. The output may be to a storage, to another instruction to be used as an input to that instruction, or other destination of an output.

As illustrated in FIG. 6, if executing the instructions on the second set of data would not necessarily produce a known result, the circuit at block 660 schedules the instructions for execution. However, the controller circuit may trigger generation of a representation of the second set of data, such as a copy of the second set of data (that is all zeros, given the criterion of this example) or other representation. The instructions can then be processed using that representation and a result of the processing output. After output in block 650 or block 660, the method 600 ends.

In the example of FIG. 6, instructions were processed on the first set of data and second set of data disparately. In some cases, instructions to be processed with a set of data may include processing two or more sets of data, only one or some of which may be sparse or otherwise meet one or more criteria. In some such cases, as noted above, loading of data that meets one or more criteria may be omitted, but instructions to process the data may be scheduled and executed. In some such cases, a representation may be created of data that meets the one or more criteria, which may be provided for processing with the other set(s) of data. The representation may be a data value or multiple data values, which may be a replication of the data that meets the one or more criteria or other representation understandable to the circuit(s) that will perform the instructions. If less than the whole data, a circuit may be configured to interpret a representation as indicative of all zeros or data otherwise meeting one or more criteria and account for such values in calculations that use other data.

FIG. 7 is a flow diagram of an example method 700 for generating metadata that includes indications of blocks of data. The steps shown in FIG. 7 can be performed by any suitable computer-executable code and/or computing system, including system 100 in FIG. 1, and/or variations or combinations of one or more of the same. In one example, each of the steps shown in FIG. 7 can represent an algorithm whose structure includes and/or is represented by multiple sub-steps, examples of which will be provided in greater detail below.

As illustrated in FIG. 7, at block 710, a system compiles a plurality of blocks of data by a compiler. At step 720, the system describes herein deduces a data pattern of each of the plurality of blocks of data through the compiler. At step 730, the system described herein includes an indication for one of the plurality of blocks of data in associated metadata if a data pattern of the one of the plurality of blocks of data satisfies at least one criterion. Examples of the criterion include a uniform data pattern. When all the data entries in the block of data are logic “0”, the uniform data pattern is uniformly logic “0”. When all the data entries in the block of data are logic “1”, the uniform data pattern is uniformly logic “1”.

As illustrated in FIG. 7, at step 740, the system described herein queries the metadata during runtime for the indication before loading the one of the plurality of blocks of data, which will result in omitting the loading as shown in FIG. 6. Therefore, the metadata facilitates the system described herein to avoid fetching zeros, or, in general, values that are the same across a block of data such as a wavefront. The metadata also facilitates the system described herein to avoid scheduling a block of data such as a wavefront that will end up calculating zeros, or, in general, a value that is the same across the wavefront.

The present disclosure employs an exemplary schedular of a computing system to omit loading and/or dispatching a block of sparse data, so that the computing system does not waste time and resource on fetching and executing the sparse data. In an implementation, the schedular makes the omitting decisions based on metadata that contains indications of the data sparsity.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example computing system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example computing system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example computing system 100 in FIG. 1 can be implemented within a virtual environment. For example, the modules and/or data described herein can reside and/or execute within a virtual machine. As used herein, the term “virtual machine” can generally refer to any operating system environment that is abstracted from computing hardware by a virtual machine manager (e.g., a hypervisor).

In some examples, all or a portion of example computing system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
prior to executing at least one instruction that is to process a first set of data stored in at least one storage, retrieving from the at least one storage a first indication of whether the first set of data satisfies at least one criterion; and
omitting loading the first set of data from the at least one storage for processing with the at least one instruction in response to the first indication indicating that the first set of data satisfies the at least one criterion.

2. The method of claim 1, further comprising omitting executing the at least one instruction in response to the first indication indicating that the first set of data satisfies the at least one criterion.

3. The method of claim 2, wherein omitting executing the at least one instruction comprises omitting loading the at least one instruction into at least one second storage.

4. The method of claim 1, wherein the at least one criterion is that the first set of data consists of zero value data.

5. The method of claim 1, wherein:
the first set of data is stored in the at least one storage as a data structure comprising at least one metadata field, the at least one metadata field of the data structure indicating whether data stored in the data structure satisfies the at least one criterion; and
retrieving the first indication from the at least one storage comprises retrieving one or more values of the at least one metadata field of the data structure for the first set of data.

6. The method of claim 1, further comprising:
loading a second set of data in response to a second indication indicating that the second set of data does not satisfy the at least one criterion; and
executing the at least one instruction with the second set of data and a data value representing the first set of data.

7. The method of claim 6, wherein executing the at least one instruction comprises:
dispatching the second set of data to one of a plurality of compute units; and
providing the data value to the one of the plurality of compute units.

8. The method of claim 1, further comprising partitioning a second set of data to obtain the first set of data satisfying the at least one criterion.

9. The method of claim 1, further comprising:
storing, in association with the first set of data, metadata indicating a data pattern of the first set of data.

10. A system, comprising:
a plurality of circuits to process data;
at least one storage coupled to the plurality of circuits; and
a controller circuit configured to:
retrieve from the at least one storage a first indication of whether a first set of data satisfies at least one criterion; and
omit scheduling the first set of data for processing by one of the plurality of circuits with at least one instruction in response to the first indication indicating that the first set of data satisfies the at least one criterion.

11. The system of claim 10, wherein the controller circuit is further configured to omit scheduling the at least one instruction for execution on one of the plurality of circuits in response to the first indication indicating that the first set of data satisfies the at least one criterion.

12. The system of claim 10, wherein:
the first set of data is stored in the at least one storage as a data structure comprising at least one metadata field, the at least one metadata field of the data structure indicating whether data stored in the data structure satisfies the at least one criterion; and
retrieving the first indication from the at least one storage comprises retrieving one or more values of the at least one metadata field of the data structure for the first set of data.

13. The system of claim 10, wherein the controller circuit is further configured to:
load a second set of data in response to a second indication indicating that the second set of data does not satisfy the at least one criterion; and
execute the at least one instruction with the second set of data and a data value representing the first set of data.

14. The system of claim 10, wherein the controller circuit is configured to process data as one of the plurality of circuits.

15. The system of claim 10, wherein the controller circuit is configured to perform the act of retrieving the first indication and configured to perform the act of omitting scheduling the first set of data for processing by performing executing instructions that, when executed by the controller circuit, cause the controller circuit to perform the retrieving and the omitting.

16. At least one computer-readable storage medium having encoded thereon executable instructions that, when executed by at least one processor, cause the at least one processor to carry out a method comprising:
compiling a program for execution by at least one circuit to process data, wherein compiling the program comprises compiling a plurality of instruction partitions of the program to be separately executed by the at least one circuit, each instruction partition of the plurality of instruction partitions being arranged to process a different set of data of a plurality of sets of data, wherein the compiling comprises, for an instruction partition of the plurality of instruction partitions:
compiling instructions of the program that allocate the set of data, that is to be processed by the instruction partition, to include instructions to associate the set of data with an indication of whether the set of data satisfies at least one criterion; and
compiling instructions of the program that store data into the set of data to include instructions additionally storing the indication of whether the set of data satisfies the at least one criterion.

17. The at least one computer-readable storage medium of claim 16, wherein the compiling further comprises, for the instruction partition of the plurality of instruction partitions:
compiling instructions of the program to include instructions that, when the instruction partition is to be scheduled for execution, refrain from scheduling the instruction partition for execution in response to the indication indicating that the set of data satisfies the at least one criterion.

18. The at least one computer-readable storage medium of claim 16, wherein the compiling to include the instructions to refrain from scheduling the instruction partition for execution comprises inserting new instructions not specified by the program to be compiled.

19. A system, comprising:
a processor comprising:
a plurality of circuits to process data;
at least one storage coupled to the plurality of circuits; and
a controller circuit configured to:
retrieve from the at least one storage a first indication of whether a first set of data satisfies at least one criterion; and
omit scheduling the first set of data for processing by one of the plurality of circuits with at least one instruction in response to the first indication indicating that the first set of data satisfies the at least one criterion.

20. The system of claim 19, wherein the controller circuit is further configured to omit scheduling the at least one instruction for execution on one of the plurality of circuits in response to the first indication indicating that the first set of data satisfies the at least one criterion.
